(19) United States
(12) Patent Application Publication
(10) Pub. No.: US 2009/0008958 A1
(43) Pub. Date: Jan. 8, 2009

(54) Automobile storage bag

(76) Inventors: Jampee Yui Sebera, Fairfax, VA (US); Frank Sebera, Fairfax, VA (US)

Correspondence Address: General Counsel, P.C., 6862 Elm Street, SUITE 800, McLean, VA, 22101, US

(21) Appl. No.: 11/824,728

(22) Filed: Jul. 2, 2007

(51) Int. Cl. B60J 11/04

(52) U.S. Cl. 296/136.1

(57) ABSTRACT

The present invention is directed to protecting an automobile from extreme weather conditions, particularly flooding. The invention comprises an automobile storage bag, and a method for shielding an automobile from extreme weather conditions. Prior to the onslaught of, or in the early stages of, hazardous weather; a user would be able to shield his automobile from flood waters by completely enclosing an automobile from the elements with the present invention. The receptacle is constructed of a material that allows it to be pliant, which allows easy storage. The automobile storage bag includes a receptacle having a terrestrial engagement surface and a fastener.

### FIELD OF THE INVENTION

The present invention generally relates to the field of automobile storage and more specifically to the field of impermeable barriers for protecting an automobile.

### BACKGROUND

An automobile is one of the most significant possessions that an individual can own. An automobile is an investment: it is the lifeblood of the citizen in that it drastically expands the range of opportunity for work, travel, vacation, and obtaining food. Furthermore, a well-maintained automobile is often a source of pride. Irrespective of the service that an automobile owner regards as most important in his automobile, automobile owners will agree that an automobile should be protected from environmental elements. Various automobile covers and shields exist to protect an automobile, yet existing forms of automobile protection suffers from various deficiencies.

The prominent form of automobile protection is an automobile cover. An automobile cover is a blanket fashioned from a material designed to protect an automobile from small to medium environmental hazards. Current automobile covers aspire to guard a covered automobile's exterior from rain, snow, acid rain, dust, UV damage, bird droppings, tree sap, and minor dings. Among car covers, there are two types: indoor covers, and outdoor covers. Indoor covers use materials that emphasize protecting the covered automobile from dust; outdoor covers use materials that emphasize protection from wind and water.

Outdoor covers, however, tend to abstain from completely waterproof materials as it is understood in the industry that covers must “breathe” and therefore cannot assure total freedom from water ingress. Without a certain amount of permeability, a cover will facilitate serious condensation buildup and create mold between the automobile and the cover. Few outdoor covers are geared toward relatively extreme environmental hazards.

One example of an outdoor cover attempting to offer protection against an extreme environmental hazard is disclosed in U.S. Pat. No. 6,220,648. The '648 patent purports to disclose a hail shield which consists of a laminated design, having multiple layers of resilient shock-absorbing material for padding, strength and shape. An outer layer of high density polyethylene (“HDPE”) mesh is layered with closed cell foam to produce a 2-ply covering material. In a preferred embodiment, a thin vinyl scrim or polyethylene sheet is layered between the HDPE mesh and the closed cell foam to provide a 3-ply covering material. The shield is constructed of two generally rectangular top panels affixed to each other along their common longest sides, each top panel being flanked by generally trapezoidally-shaped side panels. The seams between the panels are preferably constructed using a sewing technique which produces a reflexive joint between the panels, tending to fold the panels towards each other, and giving the over all hail shield a reflexive tendency to “grip” the car to increase the attachment security of the shield. The outer edges of the panels are bordered by sleeves through which elastic shock cords pass. Hooks affixed to the ends of the shock cords provide the means for attachment to the car's exterior at points such as holes in wheels or wheel covers. The design of the car shield allows for compact folding and rolling of the shield for convenient storage in a duffle-type bag in the car trunk when not in use.

Multiple patents attest to the fact that other automobiles have sought protection from the elements through the use of covers. For example, U.S. Pat. No. 4,098,536 is typical of many related patents that include covers that are designed to protect golf carts from exposure to environmental elements. The '536 patent purports to disclose a flexible sheet of at least partially transparent, water repellent material constructed to fit over the roof or canopy and sides of a golf cart for enclosure during inclement weather. An access is provided through the side wall for getting in and out of the cart and, when not in use, the weather shield may be removed from the cart, folded and stored in a pouch.

The previously-mentioned patents and those related to them—e.g. U.S. Pat. Nos. 6,761,391; 5,388,881; 4,799,728; and 5,217,275—suffer from a defect that, although likely deemed unimportant for the purposes of their respective functions, would seriously damage the protected subject matter during serious environmental turbulence. The references each disclose an exposed surface: the bottom. For extreme environmental issues, e.g. floods, water would be free to seep though the exposed surface into the interior compartments of the protected vehicles.

Protective coverings that cover all surfaces do exist for certain portable vehicles. For example, U.S. Pat. No. 4,009,744 purports to disclose a bicycle storage bag includes two side panels with lower margins which are connected together to provide a weather seal on one side of the bag above the bottom of the bag. The bag is dropped over the bicycle and the margin or flap of one side panel is folded beneath the wheels and upwardly for connection to the other panel with snap fasteners. The side panels also include openings for receiving the support hooks of vehicle bicycle racks. Draw sleeves around the openings provide a weather seal. The openings in the side panels also enable a cable or chain from a bicycle lock to be extended through the opening, around the frame and out the opening to be fastened to the bike rack or other fixture.

Although the bicycle bag of the '744 patent includes a receptacle that accommodates all of the surfaces of a bicycle, the receptacle is unsuited for extreme environmental conditions and possesses dimensions unsuitable for automobile protection.

Existing vehicle references and devices suffer from one or more of the following disadvantages: dimensions inadequate to encompass all surfaces of an automobile; water permeability; complicated fastening mechanisms; complicated storage mechanisms; and minimal protection for extreme environmental conditions. Therefore, there is a need for an automobile storage device capable of shielding all portions of an automobile from extreme environmental conditions that is simple to store and apply.

### SUMMARY

The present invention is directed to protecting an automobile from extreme weather conditions, particularly flooding. An automobile could include vehicles ranging from cars, trucks, recreational vehicles, or even sizable farm equipment. The invention comprises an automobile storage bag, and a method for shielding an automobile from extreme weather conditions. Prior to the onslaught of, or in the early stages of, hazardous weather; a user would be able to shield his automobile from flood waters.

The automobile storage bag includes a receptacle having a terrestrial engagement surface and a fastener. The receptacle has a receptacle chamber that is sized to house an entire automobile, and an automobile entrance large enough to allow an automobile to enter the automobile chamber. To prevent the ingress of water, the receptacle is water impermeable; no water can enter through its body, which includes a ventral layer and a dorsal layer. As an automobile will be resting within the receptacle, the ventral layer, i.e. the bottom layer, of the receptacle is bolstered to withstand such force. The receptacle is constructed of a material that allows it to be pliant, which allows easy storage.

The terrestrial engagement surface of the automobile storage bag is disposed on the exterior of the ventral layer. The terrestrial engagement surface includes aberrations thereon, which preferably includes excess material affixed to the bottom of the ventral layer: preferably ridges configured to prevent slippage of the bag when placed on a surface.

The fastener is affixed to receptacle so as to impermeably seal the automobile entrance. The fastener could include adhesive means, track fastening means, or zipper means.

The method for shielding an automobile from extreme weather conditions includes positioning onto a surface a substantially water impermeable, flexible plastic, foldable receptacle sized to accommodate an automobile and having an entrance sized to allow transport of the automobile into the receptacle. After the receptacle is successfully positioned, the automobile is next guided into the receptacle, which is thereafter sealed with a water impermeable seal affixed to the receptacle.

Other preferred steps for shielding an automobile from extreme weather conditions could further include controlling the humidity within the receptacle; stabilizing the receptacle onto the surface with a stabilizer; releasing the automobile from the receptacle through the receptacle entrance; and unfolding the receptacle from a storage configuration.

Therefore, it is an aspect of the present invention to effectively shield all portions of an automobile from extreme environmental conditions.

It is a further aspect of the present invention to deliver a cost effective means of protecting a vehicle to the average consumer.

It is a further aspect of the present invention to effectively shield all portions of an automobile from extreme environmental conditions with a portable, easily stored device.

It is a further aspect of the present invention to effectively shield all portions of an automobile from extreme environmental conditions with a device that is easily and relatively quickly applied.

It is a further aspect of the present invention to effectively shield all portions of an automobile from extreme environmental conditions with a device that is easily and relatively quickly removed

It is a further aspect of the present invention to effectively shield all portions of an automobile from extreme environmental conditions with a temporary barrier.

It is a further aspect of the present invention to effectively shield all portions of an automobile from extreme environmental conditions with a long-term barrier.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1A is a top, plan view of an embodiment of the automobile storage bag.

FIG. 1B is a front, plan view of an embodiment of the automobile storage bag.

FIG. 2 is a bottom, plan view of an embodiment of the automobile storage bag.

FIG. 3 is a bottom, plan view of an embodiment of the automobile storage bag.

FIG. 4 is a perspective view of an embodiment of the automobile storage bag.

FIG. 5A is a portion of the view of an embodiment of the automobile storage bag of FIG. 4, enlarged for magnification purposes.

FIG. 5B is a perspective view of a portion of an embodiment of the automobile storage bag.

FIG. 5C is a perspective view of a portion of an embodiment of the automobile storage bag.

FIG. 6 is a perspective view of an embodiment of the automobile storage bag.

FIG. 7 is a perspective view of an embodiment of the automobile storage bag.

FIG. 8 is a detailed view of an interior component of an embodiment of the automobile storage bag.

FIG. 9 is a perspective view of an embodiment of the automobile storage bag being positioned onto a surface.

FIG. 10 is a perspective view of an embodiment of the automobile storage bag accepting an automobile therein.

FIG. 11 is a side plan view of an automobile enclosed within an embodiment of the automobile storage bag.

### DETAILED DESCRIPTION

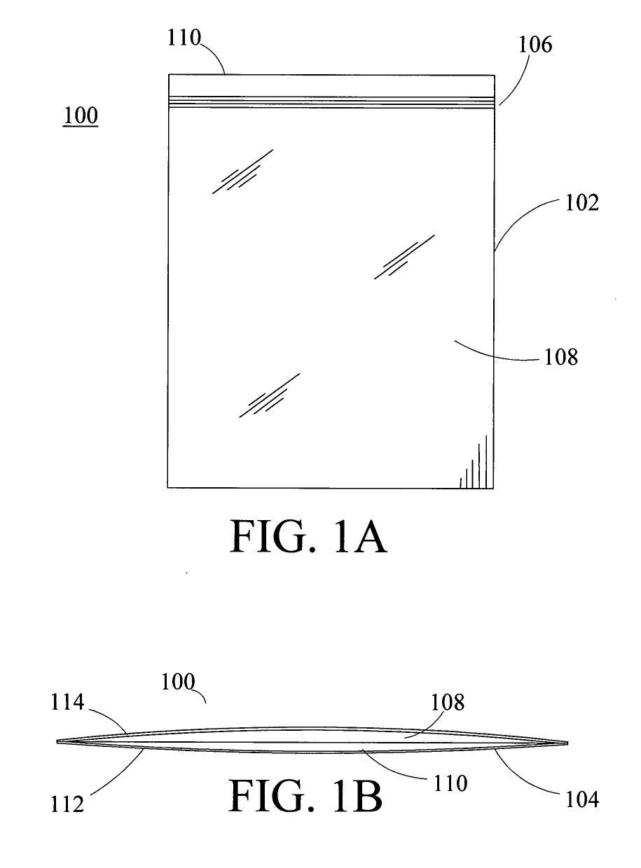

Referring first to FIGS. 1A and 1B, a basic embodiment of the automobile storage bag 100 is shown. The automobile storage bag 100 includes a receptacle 102 having a terrestrial engagement surface 104 and a fastener 106.

The receptacle 102 has a receptacle chamber 108 that is sized to house an entire automobile (not shown), and an automobile entrance 110 large enough to allow an automobile to enter the receptacle chamber 108. The size of the receptacle 102 varies, and depends upon the automobile target of the automobile storage bag 100. Embodiments of the automobile storage bag 100 may range from a potential height of approximately six feet (fully stretched), suitable for small automobiles such as tractors, to a height suitable to accommodate a recreational vehicle. Furthermore, the width of the receptacle 102 should be such that it accommodates the width of an automobile, in addition to that automobile's open door—or at least provide room for a user to exit the automobile along the side of the receptacle 102 and out through the automobile entrance. Embodiments of the automobile storage bag may include widths of six feet and greater. Furthermore, the automobile storage bag 100 will have a receptacle depth that will be sized to accommodate the length of the target automobile. Suitable depths will begin at six feet and increase to allow entry of large automobiles. The dimensions of the automobile storage 100 bag are not meant to be limited to particular sizes other than those necessary to completely encompass an automobile within the receptacle chamber 108.

The automobile entrance 110 leads directly to the receptacle chamber 108, which is the interior of the receptacle 102. The receptacle 102 is water impermeable in order to prevent the ingress of water into the receptacle chamber 108. To achieve this purpose the receptacle 102 is preferably constructed of a durable, water-impermeable material that is additionally pliant. The material should be water-impermeable to a degree that water substantially no water penetrates the receptacle. The material must be pliant to a degree that allows the bag to be folded in upon itself multiple times, though no particular number of times is necessary. Rather, the pliant nature of the material allows the automobile storage bag 100 to be condensed into a more storage-friendly configuration.

It is further preferred that the automobile storage bag 100 be constructed of a material having a significant temperature resistance. The material should be capable of maintaining its properties of pliability and water-resistance in near-freezing weather and one hundred degree Fahrenheit temperatures.

The preferred material for the automobile storage bag 100 is a plastic, in particular polymers such as polypropylene, polyethylene, polyester, or combinations thereof. In a preferred embodiment the composition of the bolstered ventral layer 112 comprises two layers of plastic film The first plastic film layer is a twelve micron polyethylene terephthalate five layer film, which is bonded to the second plastic film layer is a three layer polyethylene film with a bonding agent comprising a two part polyurethane mixture. Although other layers of the receptacle may be fabricated with this preferred composition, it is not necessary. Other plastic compositions that fulfill the aspects of the present invention may be used. For example, other known high-strength, pliable plastics may be used, such as standard polyolefins (blends or coextrusions) or, blends of linear low density ethylene and metalocene and a stiffening middle layer, such as high density polyethylene (HDPE). The dorsal layer 114 does not have a preferred particular composition, any composition capable of preventing the ingress of water yet remaining substantially pliant is acceptable. The bolstered ventral layer 112 and the dorsal layer 114 need not be constructed of the same material.

The fastener 106 of the present invention is configured to sealingly close the automobile entrance 110. The fastener 106 can be any device known is the art of bag closure that is capable of creating a water impermeable seal. Preferred means for sealing the automobile entrance include an adhesive seals or a plastic reclosable fastener seal. The adhesive seal of the present invention includes at least one adhesive strip disposed proximate to the automobile entrance on the dorsal layer, the ventral layer, or both. The adhesive strip includes an adhesive strip cover to shield the adhesive strip and prevent degradation of adhesion quality. Such adhesive strip embodiments would of course be single use. For embodiments requiring re-use, the plastic reclosable fastener is preferred. The reclosable fastener includes a zipper extending along the automobile entrance in which the zipper has a male track and a female track. A slider sealingly contacts both the male track and the female track in manner that allows slidable motion. For re-usable embodiments incapable of positioning a fastener at the periphery of the bag, as is the case for embodiments utilizing the reclosable fastener, a sealing track is preferred. The sealing track includes a female track and a male track, each dimensioned to interlock with the other.

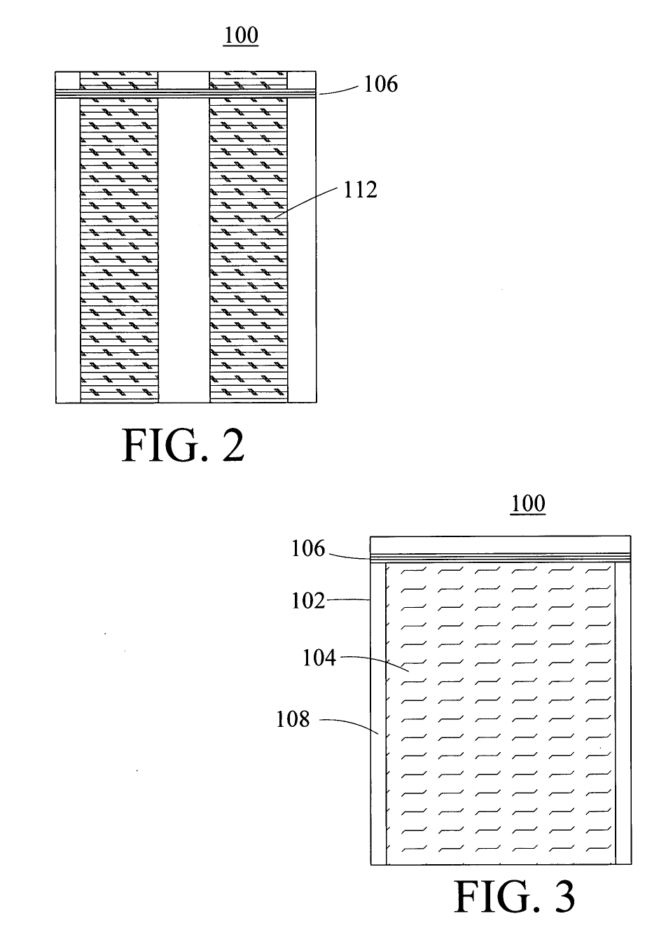

FIG. 2 shows a preferred example of the shape and structuring of the bolstered ventral layer 112. As the bolstered ventral layer 112 is structured to accept the pressure of an automobile, embodiments of the automobile storage bag 100 may include a bolstered ventral layer 112 specially shaped to contact the target automobile. As the example of FIG. 2 exhibits, one shape configuration for the bolstered ventral surface 112 could include bolstering in only the portions that would likely contact the tires of the automobile, the treads of a tractor, or perhaps the runners of a snowmobile.

As FIG. 3 shows, preferred embodiments of the automobile storage bag 100 include on the bottom of the bolstered ventral layer 112 the terrestrial engagement surface 104. The terrestrial engagement surface 104 includes aberrations thereon. These aberrations exist to create friction between automobile storage bag 100 and a surface upon which the automobile storage bag 100 may be placed. The preferred aberrations are ridges composed of plastic. Other types of terrestrial engagement surfaces are, however, possible for use in the present invention providing that such devices fulfill the basic purpose of the terrestrial engagement surface; for example patches of grip tape affixed to the bolstered ventral surface.

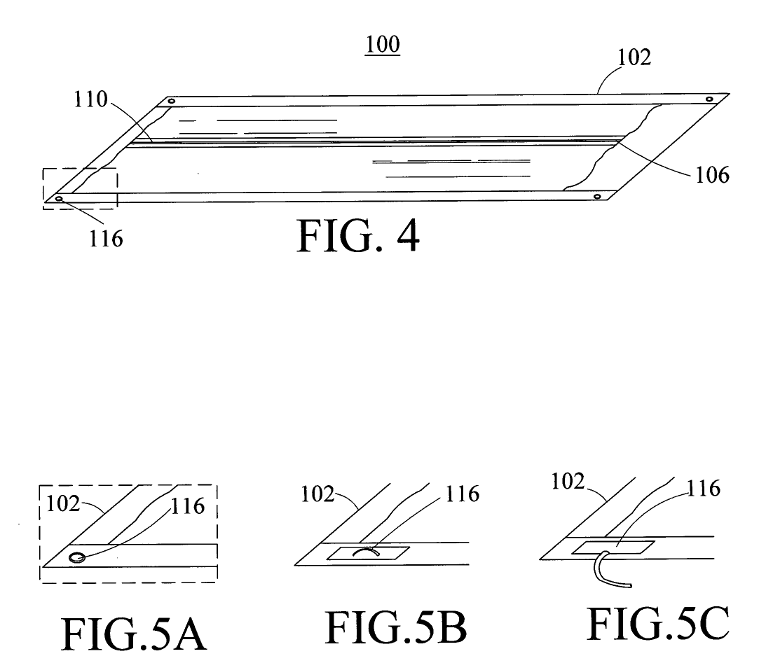

The automobile entrance 110 of the receptacle 102 is positioned to allow a targeted automobile entry into the receptacle chamber 108. The preferred location for the automobile entrance 110 is across the width of the receptacle 102, but alternative locations are possible for the automobile entrance 110. FIG. 4 exhibits an automobile entrance 110 across the length of the receptacle 102. In such embodiments, it is preferred that considerable excess material is used in fabricating the dorsal layer 114 of the receptacle 102.

As FIGS. 5A, 5B, and 5C show, embodiments of the automobile storage bag 100 could further include stabilizers 116. The stabilizers 116 exist to allow a user to affix the receptacle 102 of the automobile storage bag 100 to a stationary object, e.g. a tree, pole, or the ground. The stabilizers 116 can include eyelets, handles, an affixed line, or any other means for stabilizing the invention. It is preferred that any stabilizers are positioned onto the periphery of the receptacle.

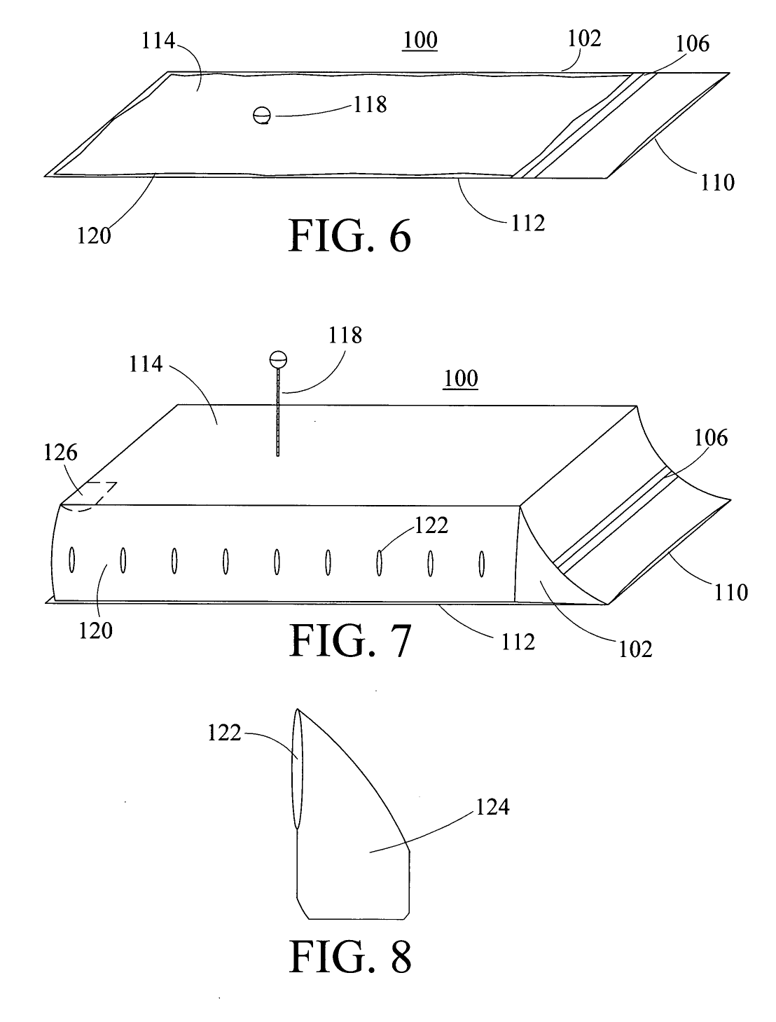

FIG. 6 depicts an embodiment of the automobile storage bag possessing a sidewall 120, water ingress apertures (not shown), water storage tanks (not shown), and a signal 118. For extreme weather conditions, it is recognized that the automobile storage bag 100 could be completely covered by flood water. In such a situation, it would be advantageous for the automobile storage bag 100 to include a signal 118 affixed to the receptacle 102. As the signal 118 should be a device that is capable of display, a buoy attached by a line to the receptacle 102 is the preferred signal. Other sorts of display items such as flag, poles, and the like, would similarly serve the purpose of the present invention.

Embodiments of the automobile storage bag 100 might further include a sidewall (not shown) connecting the dorsal layer 114 and the bolstered ventral layer 112. FIG. 7 displays the automobile storage bag of FIG. 6 as expanded. The embodiment of FIG. 7 utilizes a receptacle 102 with a sidewall 120 to expand the volume of the receptacle chamber 108 (relative to the embodiments that consist of a dorsal layer and ventral layer). The sidewall 120 can be manufactured of any material from which either the dorsal layer or the ventral layer is composed. When present, it is preferred that the sidewall 120 continuously wraps around all portions of the receptacle 102, except any portions occupied by an automobile entrance 110.

The embodiment of FIG. 7 further includes water ingress apertures 122 to allow water to accumulate within the automobile storage bag 100. As shown more clearly in FIG. 8, the water is allowed to enter the water ingress apertures 122 and flow into water storage tanks 124 affixed to the receptacle 102. Thus, no water actually flows into the receptacle chamber, which remains dry. The purpose of the water storage tanks 124 is to decrease the buoyancy of the automobile storage bag 100. In protecting any automobiles within the receptacle chamber it is important that the weight of the automobile be such that the volume of the receptacle chamber does not allow the system, i.e. automobile storage bag plus automobile, to float. The presence of one or more water storage tanks in communication with the exterior of the receptacle serves such a purpose.

Returning to FIG. 7, as an additional measure to control the humidity within the receptacle chamber, embodiments of the automobile storage bag might further include a desiccant 126, or other humidity control device, positioned to contact the air within the receptacle chamber. A desiccant is preferred over devices as such moisture absorbing materials do not require energy to operate. A preferred desiccant capable of use with the present invention is silica gel. Silica gel, which will work from below freezing to past the boiling point of water. It will lower the relative humidity in a container to around 40% at any temperature in its range until it is saturated. Other forms of desiccants capable of use with the automobile storage bag 100 include indicating silica gel, calcium oxide, calcium sulfate, clay desiccants, and the like.

It is preferred that the desiccant 126 be provided in a container that is affixed to the interior of the receptacle 102. In such a position, the desiccant 126 would be positioned to dry the air within the receptacle chamber 108. Other means for controlling the humidity within the receptacle chamber 108 are within the scope of the present invention.

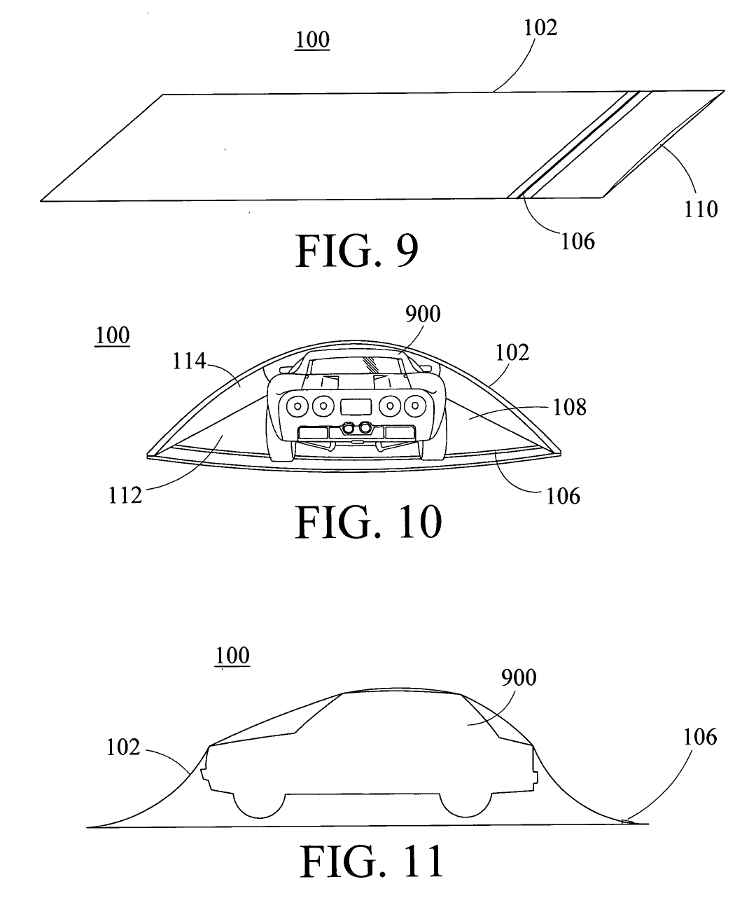

FIGS. 9-11 illustrate basic steps of the method for shielding an automobile from extreme weather conditions. An initial step, as depicted in FIG. 9 includes positioning onto a surface a substantially water impermeable, flexible plastic, foldable receptacle sized to accommodate an automobile and having an automobile 110 entrance sized to allow transport of the automobile (not shown) into the receptacle. After the receptacle 110 is successfully positioned, the automobile 900 is next guided into the receptacle 102 as shown in FIG. 10. The automobile is thereafter sealed with a water impermeable fastener affixed to the receptacle as shown in FIG. 11.

Other preferred steps for shielding an automobile from extreme weather conditions could further include controlling the humidity within the receptacle. Such a step is preferably accomplished by means of a desiccant within the receptacle and contacting the receptacle chamber. An additional step could further include stabilizing the receptacle onto the surface with a stabilizer. An additional step could further include releasing the automobile from the receptacle through the receptacle entrance. As an optional step the automobile storage bag could be in a folded state, and as a first step a user might pursue the action of unfolding the receptacle from a storage configuration.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. An automobile storage bag for protecting an automobile from extreme weather conditions, said bag comprising:
a substantially water impermeable, substantially pliant receptacle, dimensioned to accommodate an automobile, having a bolstered ventral layer and a dorsal layer, said receptacle defining a receptacle chamber and an automobile entrance dimensioned to allow transport of the automobile into said receptacle chamber;
a terrestrial engagement surface disposed upon said ventral layer; and
a fastener, affixed to said receptacle, configured to impermeably seal said automobile entrance.

2. The automobile storage bag of claim 1 wherein said receptacle is fabricated of a polymer.

3. The automobile storage bag of claim 2 wherein said receptacle is fabricated of a polymer chosen from the group consisting of polypropylene, polyethylene, and polyester, and combinations thereof.

4. The automobile storage bag of claim 3 further comprising a desiccant, in fluid communication with said receptacle chamber, affixed to said receptacle.

5. The automobile bag of claim 3 wherein said receptacle further comprises a sidewall contacting said dorsal layer and said ventral layer.

6. The automobile storage bag of claim 3 wherein said receptacle consists of said dorsal layer and said ventral layer.

7. The automobile storage bag of claim 3 wherein said bolstered ventral layer comprises wheel-base padding.

8. The automobile storage bag of claim 3 wherein said receptacle further defines water ingress apertures in fluid communication with water storage tanks.

9. The automobile storage bag of claim 3 further comprising a signal affixed to said receptacle.

10. The automobile storage bag of claim 3 wherein said receptacle further comprises stabilizers.

11. An automobile storage bag for protecting an automobile from extreme weather conditions, said bag comprising:
a substantially water impermeable, polymer receptacle dimensioned to accommodate an automobile, having a ventral layer and a dorsal layer, said receptacle having an entrance dimensioned to allow transport of the automobile into said receptacle;
terrestrial engagement means, disposed upon said ventral layer; and
fastening means, upon said receptacle, configured to impermeably seal said automobile entrance.

12. The automobile storage bag of claim 11 further comprising a moisture control means affixed to said receptacle.

13. The automobile storage bag of claim 12 further comprising signal means affixed to said receptacle.

14. The automobile storage bag of claim 12 further comprising stabilizing means affixed to said receptacle.

15. The automobile storage bag of claim 14 further comprising density enhancement means.

16. A method for shielding an automobile from extreme weather conditions, said method comprising:
positioning onto a surface a substantially water impermeable, flexible plastic, foldable receptacle dimensioned to accommodate an automobile and having an entrance dimensioned to allow transport of said automobile into said receptacle;
guiding said automobile into said receptacle; and
sealing said receptacle with a water impermeable seal affixed to said receptacle.

17. The method of claim 16 further comprising the step of unfolding said receptacle from a storage configuration.

18. The method of claim 16 further comprising the step of controlling the humidity within said receptacle.

19. The method of claim 18 further comprising the step of stabilizing said receptacle onto said surface with a stabilizer.

20. The method of claim 19 further comprising the step of releasing said automobile from said receptacle through said receptacle entrance.
